(19) United States
(12) Patent Application Publication
(10) Pub. No.: US 2013/0141353 A1
(43) Pub. Date: Jun. 6, 2013

(54) METHOD FOR UNLOCKING ELECTRONIC DEVICE AND ELECTRONIC DEVICE USING THE SAME

(71) Applicant: YAO-TING CHANG, Tu-Cheng (TW)

(72) Inventor: YAO-TING CHANG, Tu-Cheng (TW)

(73) Assignee: HON HAI PRECISION INDUSTRY CO., LTD., Tu-Cheng (TW)

(21) Appl. No.: 13/563,758

(22) Filed: Aug. 1, 2012

(30) Foreign Application Priority Data
Dec. 5, 2011 (TW) 100144737

(51) Int. Cl. G06F 3/041

(52) U.S. Cl. 345/173

(57) ABSTRACT

A method for unlocking an electronic device is provided. The electronic device includes a storage unit, the storage unit stores a relationship table which defines a number of touch modes, each touch mode includes touch icons needing to be touched, touch duration corresponding to each touch icon, a touch sequence of the touch icons and a touch order of each touch icon in the touch sequence. The method includes: selecting an touch mode from the touch modes defined in the relationship table when in a situation where the electronic device needs to be unlocked; displaying the touch icons corresponding to the touch mode on the touch screen; determining whether touches on the touch icons match the requirements of the selected touch mode; and unlocking the electronic device if the touches on the touch icons match the requirements of the selected touch mode.

### BACKGROUND

1. Technical Field

The present disclosure relates to electronic devices and, particularly, to an electronic device applying a method for unlocking the electronic device.

2. Description of Related Art

Electronic devices, such as mobile phones, digital cameras, with touch screen are popular. To prevent an electronic device being operated by unintended touches, the electronic device is locked if the electronic device has not been operated after a certain period of time or in response to user's locking operation. A method to unlock the locked electronic device is to press a special icon displayed on the locked electronic device and/or swipe along a given track, which is lack of interest.

An electronic device, with a method for unlocking the electronic device, to overcome the described limitations is thus needed.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a block diagram of an electronic device, in accordance with an exemplary embodiment.

FIG. 2 is a schematic diagram showing a relationship table defining a number of touch modes used for unlocking the electronic device of FIG. 1, in accordance with an exemplary embodiment.

FIG. 3 is a schematic diagram showing an interface displaying touch icons used for unlocking the electronic device of FIG. 1, in accordance with an exemplary embodiment.

FIG. 4 is a schematic diagram showing changes in one touch icon used for unlocking the electronic device of FIG. 1, in accordance with an exemplary embodiment.

FIG. 5 is schematic diagram showing changes in one touch icon used for unlocking the electronic device of FIG. 1, in accordance with another embodiment.

FIG. 6 is flowchart illustrating a method for unlocking an electronic device, such as that of FIG. 1, in accordance with an exemplary embodiment.

### DETAILED DESCRIPTION

Embodiments of the present disclosure will be described with reference to the accompanying drawings.

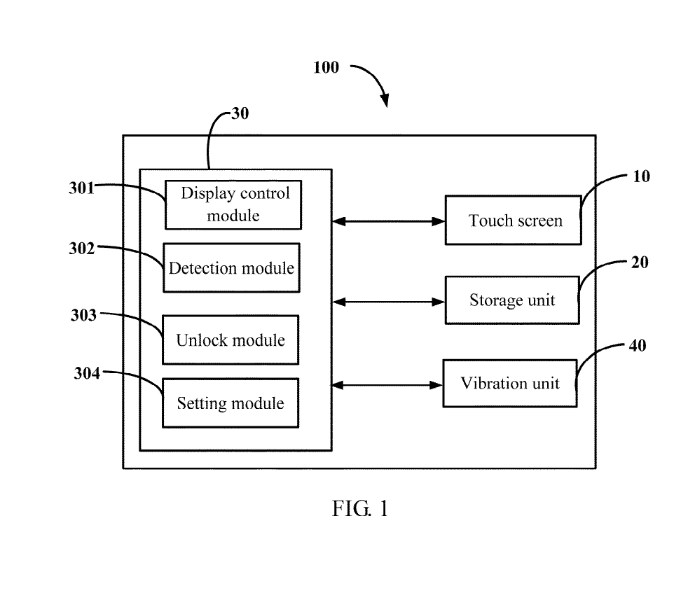

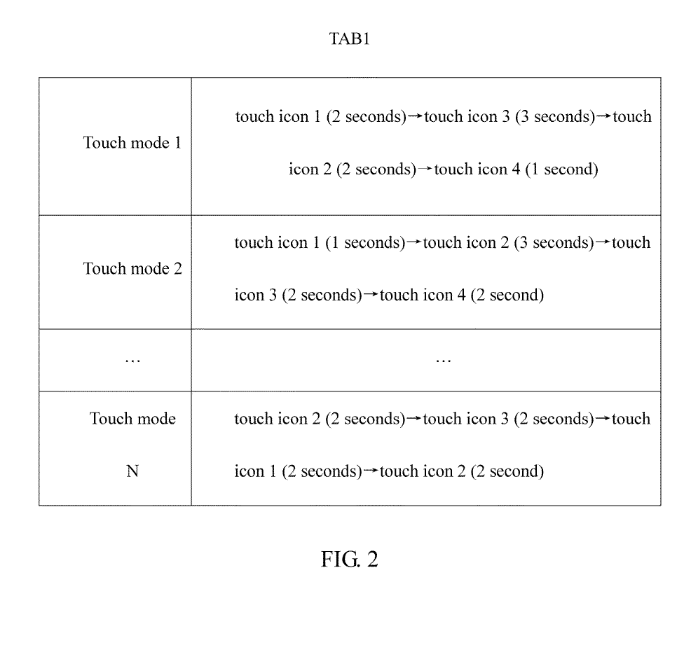

Referring to FIG. 1, an electronic device 100 is illustrated. The electronic device 100 includes a touch screen 10, a storage unit 20, and a processing unit 30. The touch screen 10 is used to display operation interfaces and produce signals in response to user's touches. The storage unit 20 stores a relationship table TAB1 as shown in FIG. 2, which defines a number of touch modes. Each of the touch modes defines a number of touch icons which need to be touched to unlock the device 100, a touch duration corresponding to each touch icon, a touch sequence of the touch icons, and a touch order of each touch icon in the touch sequence. Therein, the touch duration corresponding to each touch icon is the minimum time required when touching the corresponding touch icon. For example, as shown in FIG. 2, the number of the touch icons of each touch mode is four, however, the number of the touch icons can be changed according to need, such as three or less, or five or more.

The processing unit 30 includes a display control module 301, a detection module 302, and an unlock module 303. The display control module 301 selects a touch mode and displays touch icons on the touch screen 10 when determining whether the electronic device 100 should be unlocked. When the electronic device 100 is unlocked, namely in an unlocked state, if a user presses a power key (not shown) of the electronic device 100, then the electronic device 100 determines that the user intends/needs to unlock the electronic device 100, and displays an unlock interface on the touch screen 10. In one embodiment, the display control module 301 randomly selects one touch mode from the touch modes defined in the relationship table TAB1. In another embodiment, the display control module 301 selects one touch mode in a sequence, such as if the display control module 301 previously selected the touch mode 2, then the display control module 301 selects the touch mode 3 at this time.

The detection module 302 is used to detect touches on the touch screen 10 and then to detect whether the touches on the touch icons match requirements of the selected touch mode. Namely, the detection module 302 detects whether the touch icons corresponding to the touch mode are touched according to the touch sequence as defined in the relationship table TAB1 and whether the duration of the touch on each touch icon maintains the touch duration of the touch icon defined in the relationship table TAB1. For example, as shown in FIG. 2, when the touch mode 1 is selected by the display control module 301, if the user touches the touch icon 1 first, and the touch duration exceeds 2 seconds, then touches the touch icon 3 and the touch duration exceeds 3 seconds, then touches the touch icon 2 and the touch duration exceeds 2 seconds, and then touches the touch icon 4 and the touch duration exceeds 1 second, then the detection module 302 will determine that the touches on the touch icons match the requirements of the selected touch mode 1.

In detail, the detection module 302 first detects whether a particular touch icon needs to be touched first in the selected touch mode, and then determines whether the duration of touch on that first touch icon exceeds the predefined touch duration. The detection module 302 then detects whether the duration of touch on the touch icon which is to be touched second in the mode exceeds the predefined touch duration. Then, the detection module 301 determines whether the touches on the touch icons match the requirements of the selected touch mode until the detection module 301 detects that all of the touch icons of the selected touch mode have been touched correctly according to the touch sequence and the duration of touch on each touch icon respectively exceeds the touch duration of the touch icon defined in the relationship table TAB1.

In one embodiment, the detection module 302 also detects that whether a time gap between touches on two adjacent icons is within a predetermined time (such as 5 seconds). If the detection module 301 determines that the time gap between such touches is not within the predetermined time, the detection module 302 clears and awaits the first touch on the first icon again.

The unlock module 303 unlocks the electronic device 100 when the detection module 302 determines that all the touches on the touch icons match the selected touch mode.

In the embodiment, as shown in FIG. 2, in one touch mode, the touch icons corresponding to different touch sequences can be the same icons or different ones, and the touch duration of the touch icons can also be the same or different. Such as, in touch mode N, the touch icon relevant to touch sequence 1 and the touch icon relevant to touch sequence 4 are both touch icon 2, and the touch duration for each touch on touch icon 2 is the same in both touch modes. In touch mode 1, the touch icons for different touch orders are different, and the touch duration for some of the touch icons are the different.

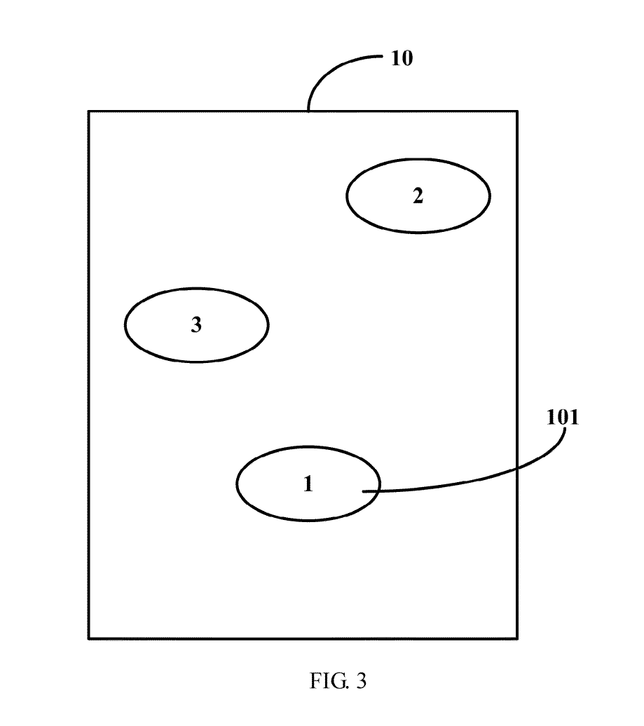

Referring to FIG. 3, in one embodiment, the display control module 301 displays all of the touch icons of the selected touch mode on the touch screen 10 at the same time. The display control module 301 displays an indication to indicate the touch sequence of each touch icon. Such as, as shown in FIG. 3, each icon carries an order number to indicate the sequence in which it is to be touched. In another embodiment, the display control module 301 displays the touch icons in sequence according to the touch sequence of the touch icons as defined in the relationship table TAB1. In one embodiment, the display control module 301 displays the touch icons on a random area of the touch screen 10 in sequence or at the same time. In another embodiment, each touch icon of the selected touch mode has its own “private” display area, and the display control module 301 displays each touch icon on its individual area of the touch screen 10 in sequence or at the same time.

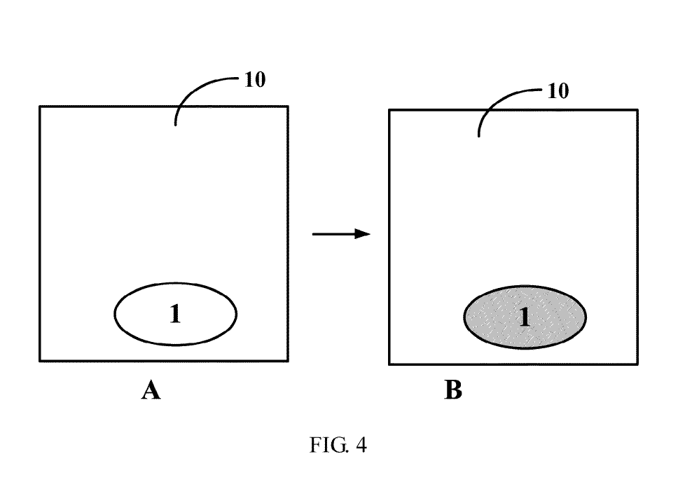

Referring to FIG. 4, in one embodiment, when one touch icon with a color is be touched, if the duration for touching the touch icon has exceeded the predefined touch duration, the display control module 301 controls the touch icon to be displayed in another color to inform the user. For example, as shown in “A” of FIG. 4, when the touch icon has yet to be touched, the color of the touch icon is white, and when the duration of touching the touch icon has exceeded the predefined touch duration, the display control module 301 controls the touch icon to be displayed in gray or other color as shown in “B”.

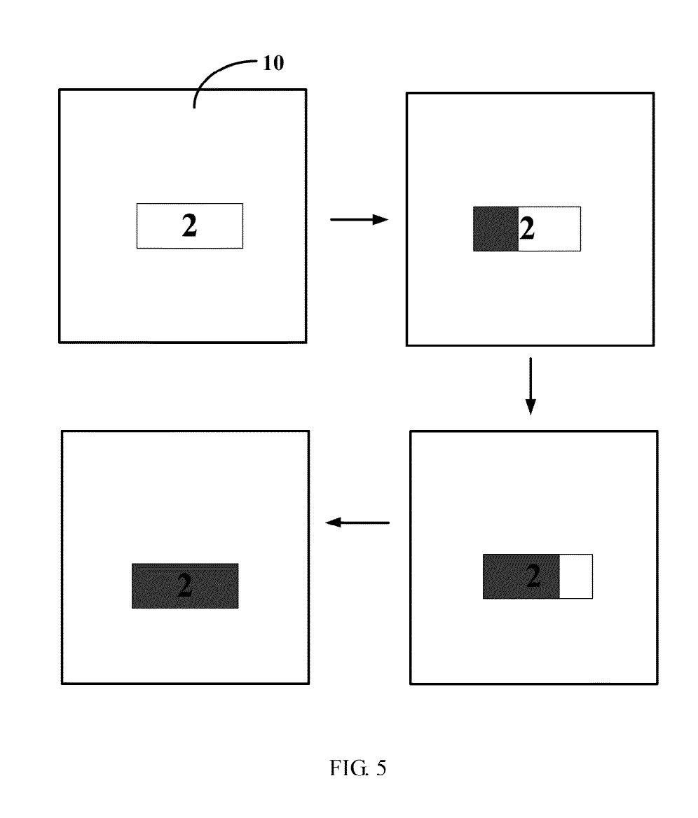

Referring to FIG. 5, in another embodiment, when one touch icon with a color is awaiting a necessary touch, the display control module 301 controls the display of the touch icon to gradually fill with another color, and when a touch duration for the touch icon exceeds the predefined touch duration, the display control module controls the touch icon to switch to a display in another color completely, thereby giving a visual indication to the user to assist the user in moving through the system procedure.

In one embodiment, the processing unit 30 also includes a setting module 304. The setting module 304 is used to set the touch icons, the touch sequence of each icon, and the touch duration of each icon of each touch mode of the relationship table TAB1, in response to user's operation. The setting module 304 also can set to display the touch icons on the touch screen 10 at the same time or to display the touch icons in sequence, in response to user's operation.

In one embodiment, the electronic device 100 also includes a vibration unit 40, the detection module 302 also controls the vibration unit 40 to vibrate when detecting that the duration of touch has exceeded the predefined touch duration, thereby informing the user that the duration of touching the current touch icon satisfies the requirement.

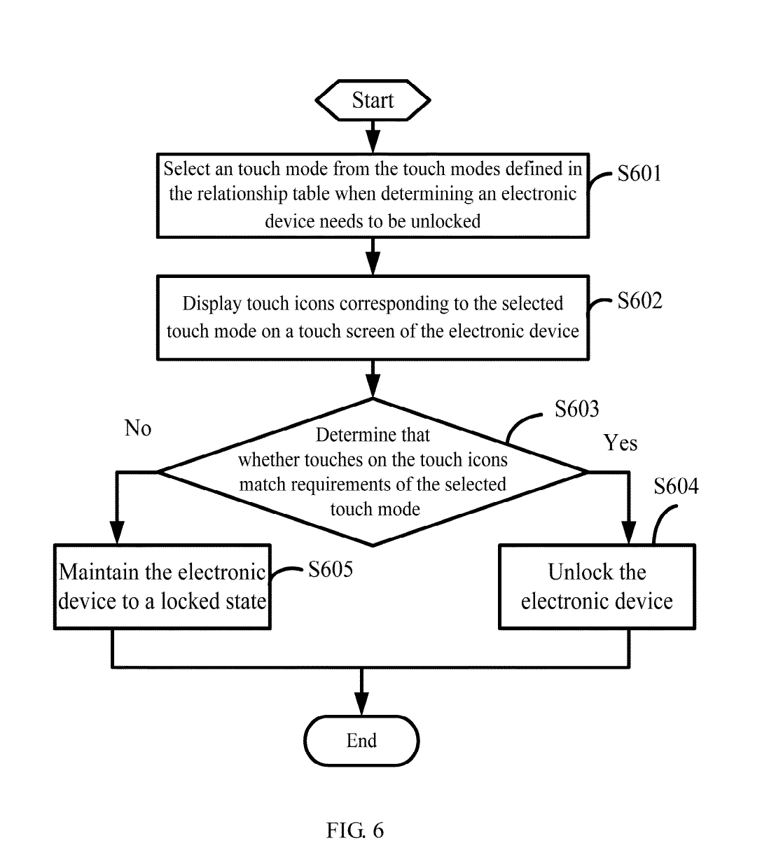

Referring to FIG. 6, a flowchart illustrating a method for unlocking an electronic device is shown. The method is applied in the electronic device 100 as shown in FIG. 1. In step S601, the display control module 301 selects a touch mode from the touch modes defined in the relationship table TAB1 when determining that the electronic device 100 is intended to be unlocked. In one embodiment, the display control module 301 selects a random touch mode from the touch modes defined in the relationship table TAB1. In another embodiment, the display control module 301 selects the next touch mode in the sequence from the touch modes defined in the relationship table TAB 1. Therein, the relationship table TAB 1 defines a number of touch modes, each touch mode includes a number of touch icons needing to be touched, a touch duration corresponding to each touch icon, a touch sequence of the touch icons, and a touch order of each touch icon in the touch sequence.

In step S602, the display control module 301 displays touch icons corresponding to the selected touch mode.

In step S603, the detection module 302 determines whether the touches on the touch icons match the requirements of the selected touch mode by detecting whether the touch icons are touched in sequence as defined in the relationship table TAB1 and the required duration of the touch on each touch icon is achieved as defined in the relationship table TAB1.

If the detection module 302 determines that the touches on the touch icons match the requirements of the selected touch mode, in step S604, the unlock module 303 unlocks the electronic device 100.

If the detection module 302 determines that the touches on the touch icons do not match the requirements of the selected touch mode, in step S605, the unlock module 303 does not unlock the electronic device 100.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. An electronic device comprising:
a touch screen;
a storage unit storing a relationship table, wherein, the relationship table defines a number of touch modes, each touch mode defines touch icons need to be touched, touch duration corresponding to each touch icon, a touch sequence of the touch icons, and a touch order of each touch icon in the touch sequence; and
a processing unit, comprising:
a display control module, configured to select a touch mode and display the touch icons corresponding to the selected touch mode on the touch screen when determining the electronic device is need to be unlocked;
a detection module, configured to detect touches on the touch screen, and to detect whether the touch icons corresponding to the touch mode is be touched in sequence as defined in the relationship table and whether a duration of the touch on each touch icon exceeds the touch duration of the touch icon defined in the relationship table, so as to determine whether the touches on the touch icons match requirements of the selected touch mode; and
an unlock module, configured to unlock the electronic device when the detection module determines that the touches on the touch icons match the requirements of the selected touch mode.

2. The electronic device according to claim 1, wherein, the detection module determines the touches on the touch icons match the requirements of the selected touch mode when detecting that the touch icons corresponding to the touch mode is touched in sequence as defined in the relationship table and a duration of the touch on each touch icon exceeds the touch duration of the touch icon defined in the relationship table.

3. The electronic device according to claim 1, wherein if the detection module detects that a time gap between two adjacent icons does not within a predetermined time, the detection module clears and awaits a touch on a touch icon corresponding to a first touch order is touched again.

4. The electronic device according to claim 1, wherein the display control module displays all of the touch icons of the selected touch mode on the touch screen at the same time, and displays an indication to indicate the touch sequence of each touch icon on the touch screen.

5. The electronic device according to claim 1, wherein the display control module displays the touch icons in sequence according to the touch order of the touch icons defined in the relationship table.

6. The electronic device according to claim 1, wherein when one touch icon is be touched, if a duration of touching the touch icon has exceeded the predefined touch duration, the display control module further controls to change a color of the touch icon to prompt the user.

7. The electronic device according to claim 1, wherein when one touch icon with a color is touched, along with the time touching the touch icon is passed, the display control module controls a display of the touch icon to gradually fill with another color, and when a duration of touching the touch icon exceeds the predefined touch duration, the display control module controls the touch icon to switch to the display in the another color completely.

8. The electronic device according to claim 1, wherein the electronic device further comprises a vibration unit, the detection module is further configured to control the vibration unit to vibrate when detecting a duration of touching one touch icon exceeds the predefined touch duration.

9. A method for unlocking an electronic device, wherein, the electronic device comprises:
a touch screen; and
a storage unit storing a relationship table, wherein, the relationship table defines a number of touch modes, each touch mode defines touch icons need to be touched, touch duration corresponding to each touch icon, touch sequence of the touch icons, and a touch order of each touch icon in the touch sequence,
the method comprising:
selecting a touch mode from the touch modes defined in the relationship table when determining the electronic device needs to be unlocked;
displaying the touch icons corresponding to the selected touch mode on the touch screen;
determining that whether touches on the touch icons match requirements of the selected touch mode by detecting that whether the touch icons corresponding to the touch mode is be touched in sequence as defined in the relationship table and duration of the touch on each touch icon exceeds the touch duration of the touch icon defined in the relationship table;
unlocking the electronic device if determining that the touches on the touch icons match the requirements of the selected touch mode.

10. The method according to claim 9, further comprising:
controlling the electronic device to maintain a locked state if determining that the touches on the touch icons do not match the requirements of the selected touch mode.

11. The electronic device according to claim 9, wherein the step “selecting a touch mode from the touch modes defined in the relationship table” comprising:
selecting a random touch mode from the touch modes defined in the relationship table.

12. The method according to claim 9, wherein the step “selecting a touch mode from the touch modes defined in the relationship table” comprising:
selecting a touch mode from the touch modes defined in the relationship table in sequence.

13. The method according to claim 9, wherein the step “displaying the touch icons corresponding to the touch mode on the touch screen” comprising:
displaying the touch icons corresponding to the selected touch mode on the touch screen at the same time.

14. The method according to claim 9, wherein the step “displaying the touch icons corresponding to the touch mode on the touch screen” comprising:
displaying the touch icons in sequence according to the touch order of the touch icons defined in the relationship table.
